(19) United States
(12) Patent Application Publication
(10) Pub. No.: US 2016/0137301 A1
(43) Pub. Date: May 19, 2016

(54) PASSENGER CONTROL CENTER

(71) Applicant: Anthony J. Jackson, Port Charlotte, FL (US)

(72) Inventor: Anthony J. Jackson, Port Charlotte, FL (US)

(21) Appl. No.: 14/546,506

(22) Filed: Nov. 18, 2014

(51) Int. Cl. B64D 11/06

(52) U.S. Cl. CPC B64D 11/0602; B64D 11/0606

(57) ABSTRACT

A passenger control center for an airplane comprising: a pair of seats; a dome enclosing the pair of seats; a base supporting the dome and the pair of seats; a solar panel on a top surface of the dome; a back panel for the dome, where the back panel stores a parachute; a hinge along a rear edge of the base; and a beacon warning indicator in the center of the solar panel. The passenger control center serves as means to survive an accident or emergency on an aircraft. The passenger control center is preferably ejectable and thus provides a means for safe escape and survival of an air disaster

### BACKGROUND OF THE INVENTION

1. Field of Invention

The present invention relates to a self-contained unit that provides seating and an emergency evacuation device airplane passenger.

2. Description of Related Art

One of the most popular forms of travel involves air flight on commercial airplanes. Presently thousands of planes are utilized each day by even more thousands of passengers. Basically the typical airplane includes a captain's cockpit, at least one galley and a passenger area that includes several rows of seats. The current format for seating is a typical backrest seat with armrests. The seats presently are designed to have minimum size so that the maximum number of seats are placed within the cabin of the plane. One drawback to the traditional passenger seat is that the seat fails to provide any significant safety protection or assistance in case of emergency, accident or plane crash. Although it's commonly known that the seat cushion may be used as a floatation device however in most instances if a plane does crash the consequences are dire for most passengers on the plane.

Some of the prior art has contemplated using ejection systems where passengers are able to eject from a plane and use the seat with a parachuting apparatus in order to eject and safely parachute to safety. One example of such an ejection system is depicted in U.S. Pat. No. 6,695,257 to Lin. Lin discloses a passenger ejection system that includes a seat, which is propelled from a passenger plane and a parachute ejects to allow for the passenger to float to safety with the parachute and release from the seat. Although such similar systems are discussed in the prior art many lack some of the essentials of safety, rescue and recovery. Although a passenger may actually survive such an ejection there is a likelihood that the passenger may suffocate due to the lack of oxygen at high altitudes and further if the passenger does make it to the ground there is a likelihood that the passenger may not be able to survive once the landing accomplished. As a consequence, it would be advantageous to have a complete passenger ejection system that addresses the drawbacks of the prior art and provides a complete system for survival for the ejected passenger.

### SUMMARY OF THE INVENTION

The present invention relates to a passenger control center for an airplane comprising: a pair of seats; a dome enclosing the pair of seats; a base supporting the dome and the pair of seats; a solar panel on a top surface of the dome; a back panel for the dome, where the back panel stores a parachute; a hinge along a rear edge of the base; and a beacon warning indicator in the center of the solar panel. The passenger control center serves as means to survive an accident or emergency on an aircraft. The passenger control center is preferably ejectable and thus provides a means for safe escape and survival of an air disaster.

Preferably, the pair of seats include seatbelts and an airbag is stored in the front portion of the base that deploy upon impact. Further other features may be included in the passenger control center such as oxygen masks, dome lights, ventilators, a GPS system integrated within the control unit, environmental and ground impact control elements and an airbag system. Preferably, the passenger control center also includes a parachute, which ejects after the unit has been ejected from an airplane.

### BRIEF DESCRIPTION OF DRAWINGS

FIG. 1 depicts a perspective view of a passenger control center in accordance with the present invention.

FIG. 2 depicts an alignment of a grouping of passenger control centers within the cabin of an exemplary airplane.

FIG. 3 depicts a back view of the passenger control center in accordance with the present invention.

### DETAILED DESCRIPTION

The present invention relates to a passenger control center that is used to provide a seating arrangement for passengers on the airline. The passenger control center is a self-contained unit that creates a complete survival unit in case of any type of airplane emergency. The passenger control center according to present invention ejects from an airplane and includes two twin seats per unit. Also other features may be included in the control center such as seatbelts in the form of lap and shoulder belts, oxygen masks, dome lights, ventilators, a GPS system integrated within the control unit, environmental and ground impact control elements and an airbag system. The passenger control center also includes a parachute, which ejects after the unit has been ejected from an airplane. Further the base of the control unit converts to an inflatable floatation device. As a consequence, the passenger control center according to present invention is a complete unique unit that provides a safe ejectable containment for the passenger and increases the likelihood of survival and rescue upon landing after deployment. Further other aspects to assist with survival include a food ration along with water all contained within the unit. Further the unit may include lighting and oxygen masks that drop from the roof of the unit.

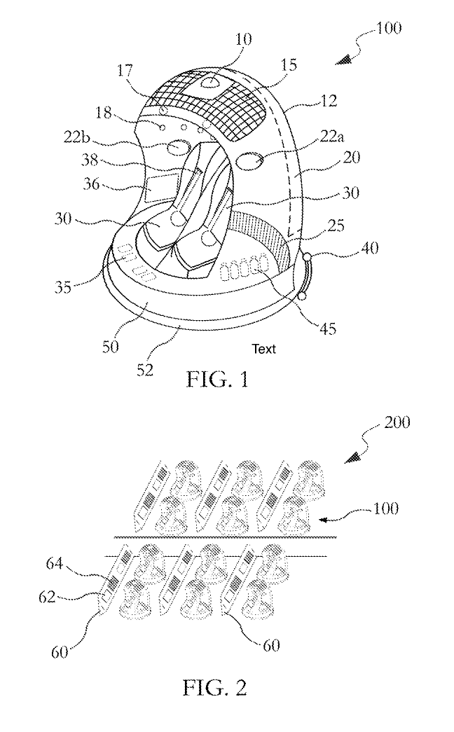

In the reference to FIG. 1, a Passenger Control Center 100 in accordance with the present invention is depicted. As shown the passenger control unit includes two Seats 30 within the unit. The seats also include Seatbelts 38 for each seat. The Seatbelts 38 include a lap belt and a shoulder harness. Airbags 35 are stored in the front of a Base 50 of the control center 100, which deploy upon impact. The Passenger Control Center 100 further includes a durable Base 52. The Base 52 inflates and creates a floatation device to support the Control Center 100 if the center should land in a body of water.

The Passenger Control Center 100 includes numerous features to first assist in the safe landing of the unit after ejection from the airplane and assists with the survival of passengers within the control unit. The passenger control center includes a Beacon Warning Indicator 10 at that the top peak of a dome roof of the Passenger Control Center 100. Surrounding the Beacon Warning Indicator 10 is a Solar Collection Panel 15. The Beacon Warning Indicator 10 provides a means to locate the Passenger Control Center 100 after ejection. The Solar Collection Panel 15 provides a means to create and generate energy for the control systems related to the Passenger Control Center 100. The present invention further includes Oxygen Masks 17 that drop down along the front perimeter of the passenger opening into the Passenger Control Center 100. Within the inner surface of the Passenger Control Center 100 is a plurality of Lights 18 preferably in the form of LED lights that provide lighting for the inner compartment of the passenger control center. Also the passenger control center includes viewing Windows 22a, 22b on each side of the passenger compartment. In terms of survival accessories, a Compartment 36 is provided that stores a ration of food preferably in the form of a three-day food ration. Also on the opposing side of the passenger control center is a Storage Area 45 for a water ration. Aligning one side of the control center is a Battery Compartment 25 that stores batteries. These batteries may be charged through the Solar Panels 15 at a place on the top surface of the passenger control center.

A Hinge 40 is provided on the rear of the passenger control center that locks the control center into place when the control center is mounted within the interior of the airplane. In reference to FIG. 2, an exemplary portion of an airplane is shown that includes passenger control centers as seating. As shown the passenger control centers are two abreast on each side of a center aisle of the airplane. In front of each row of passenger control centers is a Console 60 that includes a Power Box 64 and a Display Panel 62 preferably in the form of LCD display panel. This system provides a communication means for each passenger control unit placed within the interior of the airplane.

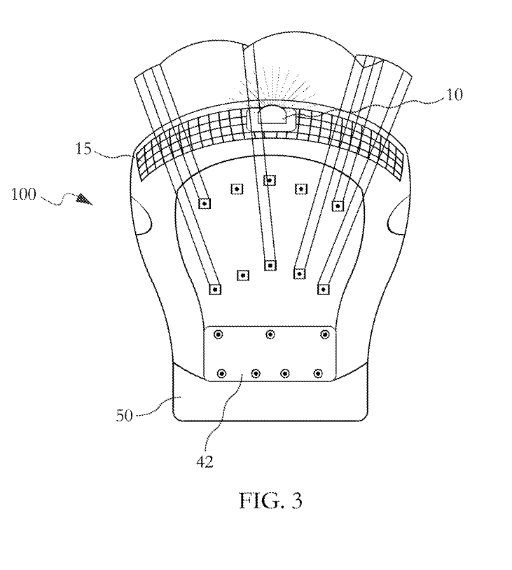

During use the Passenger Control Center 100 also includes a main parachute stored a back Panel 12 of the Control Center 100. The parachutes are deployed from a Chute Compartment 42 after the Control Center 100 is ejected from the airplane, as shown in FIG. 3. The outer shell of the control center is made of a hard durable plastic shell that can withstand some degree of impact. The base of the control center preferably is made of a kelvar base that provides some heat protection in case of fire within the airplane. As a consequence, the passenger control center according to the present invention provides a complete ejection center to provide protection and a safe landing from an airplane accident or emergency. The system is unique in the concept of durability, protection and survivability of the passengers within each control unit.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A passenger control center for an airplane comprising:
a. a pair of seats;
b. a dome enclosing the pair of seats;
c. a base supporting the dome and the pair of seats;
d. a solar panel on a top surface of the dome;
e. a back panel for the dome, where the back panel stores a parachute;
f. a hinge along a rear edge of the base; and
g. a beacon warning indicator at the center of the solar panel.

2. The passenger control center according to claim 1, where the pair of seats include a seatbelts and airbags is stored in the front portion of the base, where the airbags deploy upon impact.

3. The passenger control center according to claim 1, a set of oxygen masks in the top of the dome.

4. The passenger control center according to claim 1, where the base is inflatable to a floatation device.

5. The passenger control center according to claim 1, further including a plurality of lights within an inner surface of passenger control center and said plurality of lights provide lighting for the interior of the passenger control center.

6. The passenger control center according to claim 1, further including viewing windows on each side of the passenger control center.

7. The passenger control center according to claim 1, further including a food storage compartment.

8. The passenger control center according to claim 7, where the food storage compartment includes food rations for at least three days.

9. The passenger control center according to claim 1, further including a water storage area, which stores potable water.

10. The passenger control center according to claim 1, further including a battery compartment that stores batteries, where the batteries are charged via the solar panel.

11. The passenger control center according to claim 1, where the base includes a kelvar cover.
